(19) United States
(12) Patent Application Publication
(10) Pub. No.: US 2026/0359914 A1
(43) Pub. Date: Nov. 12, 2026

(54) ELECTRONIC INFRASTRUCTURE FOR ON-LINE LEARNING, SKILLS ASSESSMENT, AND/OR RECRUITING

(71) Applicant: Cheryl Renee Garland, Cedar Park, TX (US)

(72) Inventor: Cheryl Renee Garland, Cedar Park, TX (US)

(21) Appl. No.: 19/651,469

(22) Filed: Apr. 17, 2026

Related U.S. Application Data
(60) Provisional application No. 63/801,516, filed on May 7, 2025.

(51) Int. Cl. G06Q 50/20; G06Q 10/1053

(52) U.S. Cl. CPC G06Q 50/20; G06Q 10/1053

(57) ABSTRACT

Example methods, apparatuses, and/or articles of manufacture are disclosed that may be implemented, in whole or in part, to facilitate or support one or more operations or techniques for electronic infrastructure for on-line learning, skills assessment, and/or recruiting, such as implemented, in whole or in part, via a host computer application in connection with one or more communication networks and/or protocols for use in or with communication devices, which may include, for example, mobile communication devices.

### BACKGROUND

### 1. Field

The present disclosure relates generally to electronic infrastructures and, more particularly, to electronic infrastructure for on-line learning, skills assessment, and/or recruiting, such as implemented, in whole or in part, via a host computer application in connection with one or more communication networks and/or protocols for use in or with communication devices, which may include, for example, mobile communication devices.

### 2. Information

For many, a formal education, such as at an educational institution (e.g., public, private, etc,), for example, may be a pathway to developing requisite skills for more successful entry into the workforce. At times, a typical educational institution, however, may lack resources to help students correlate what they learn with their future endeavors. In some instances, SATs and other forms of testing may provide some useful information about a student's performance in school but may not fully reflect a student's readiness and/or aptitude for a job market. Although many schools may include career-readiness workshops or like programs, these workshops or programs may lack suitable technological infrastructure to facilitate and/or support more effective and/or more efficient skills development, assessment, learning, etc., to kept up with technology.

Accordingly, how to implement electronic infrastructure for on-line learning, skills assessment, and/or recruiting, such as to improve or otherwise enhance a preparation process, such as to help future and/or current workers to enter and/or succeed in the workforce, continues to be an area of development.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating features associated with an implementation of an example operating environment.

FIG. 2 is a schematic representation of an electronic infrastructure for on-line learning, skills assessment, and/or recruiting, according to an implementation.

FIG. 3 is a process flow of an electronic infrastructure for on-line learning, skills assessment, and/or recruiting, according to an implementation.

FIG. 4 is a schematic representation of the access level rules used, in whole or in part, by an electronic infrastructure for on-line learning, skills assessment, and/or recruiting, according to an implementation.

FIG. 5 is a schematic representation of the registration operations of an electronic infrastructure for on-line learning, skills assessment, and/or recruiting, according to an implementation.

FIG. 6 is a schematic representation of the student activities/features of an electronic infrastructure for on-line learning, skills assessment, and/or recruiting, according to an implementation.

FIG. 7 is a schematic representation of the activity algorithm and student profile of an electronic infrastructure for on-line learning, skills assessment, and/or recruiting, according to an implementation.

FIG. 8 is a process flow of an electronic infrastructure for on-line learning, skills assessment, and/or recruiting, according to an implementation.

FIG. 9 is a schematic representation of the recruiting and empowerment tools of an electronic infrastructure for on-line learning, skills assessment, and/or recruiting, according to an implementation.

FIG. 10 is a process flow of recruiting tool operations of an electronic infrastructure for on-line learning, skills assessment, and/or recruiting, according to an implementation.

FIG. 11 is a process flow of empowerment tool operations of an electronic infrastructure for on-line learning, skills assessment, and/or recruiting, according to an implementation.

FIG. 12 is a schematic representation of incentivization by an electronic infrastructure for on-line learning, skills assessment, and/or recruiting, according to an implementation.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

Some example methods, apparatuses, and/or articles of manufacture are disclosed herein that may be used, in whole or in part, to facilitate and/or support one or more operations and/or techniques for an electronic infrastructure for on-line learning, skills assessment, and/or recruiting. As discussed below, in some instances, an electronic infrastructure for on-line learning, skills assessment, and/or recruiting (hereinafter, “electronic infrastructure”) may facilitate and/or support one or more operations and/or techniques in the form of a host application being executed on a suitable client device, such as via computer-readable instructions. As a way of illustration, a client device may include, for example, a mobile device, a desktop computer, a laptop computer, or like computing device capable of facilitating and/or supporting engagement with a host application.

As will be seen, at times, an electronic infrastructure may be used, in whole or in part, in an educational environment, wherein educational environment may be defined to include, but may not be limited to, secondary (e.g., kindergarten through twelfth grade) schools, public schools, private schools, home schooling environments, colleges, including community colleges, universities, vocational school, trade school, online learning infrastructures, adult learning facilities, training facilities, gaming clubs, and competitive environments, such as but not limited to, competitive sports, triathlons, running races, bicycle races, sports leagues, gaming apps, etc., staffing agencies, job boards, recruiting companies, and so on.

For purposes of illustration, users of an electronic infrastructure may be described herein to include students, teachers, parents/guardians, educational institutions, and employers, although users of the electronic infrastructure may be not limited to these groups. Furthermore, while the example “educational institution” used, in whole or in part, for examples in the drawings and descriptions below features K-12th grade secondary schools, the principles described herein may apply to any environment, educational or otherwise, including those not yet contemplated or to be developed. While the users of an electronic infrastructure may extend beyond students, it is, in an implementation, the students whose usage of an electronic infrastructure may be made available on the client device, while teachers, parents/guardians, educational institutions, and/or employers may be, in an implementation, users and, in another implementation, customers of the electronic infrastructure, where customers may or may not pay a fee for use of an electronic infrastructure, which may depend on a particular implementation, context, educational institution, whether a customer is considered a user, or like.

In one or more aspects, an electronic infrastructure may include, for example, a registration component, in which a user may provide registration information to the app loaded on a client device. As discussed below, in some instances, a registration information may be used, at least in part. to produce a profile of a user. It is contemplated that a registration component may have different registration levels, some of which may be secured, as appropriate, to protect confidential and/or sensitive information of a user, and one or more operations or techniques may be implemented, at least in part, to store registration information, whether on a client device, on a cloud device, or a server accessible to the client device via a network, and so on.

In one or more aspects, an electronic infrastructure may make available a profile based, at least in part, on a registration information of the a (e.g., a user profile, student profile, etc.). A profile may be stored on a client device, on a cloud device or a server accessible to the client device via a network, and so on. In one or more aspects, an electronic infrastructure may make available a companion based, at least in part, on the registration information of the user. As discussed below, in some instances, these or like one or more operations or techniques may be implemented, in whole or in part, via a companion, which may generate interactive content as part of an electronic infrastructure. In an implementation, a companion may utilize, in whole or in part, Artificial Intelligence (AI) or like technology in generating and aggregating one or more aspects of interactive content.

As discussed below, in some instances, interactive content for an electronic infrastructure may incorporate one or more elements of game design. In one or more aspects, this or like gamified interactive content may be based, in whole or in part, on a profile and may be made available to a suitable process in an interaction with a companion of a client device. Further, one or more operations or techniques may be employed, in whole or in part, which may implement a suitable rewards system that may be associated with one or more aspects of interactive content of an electronic infrastructure. A rewards system may be implemented, in whole or in part, for example, in connection with one or more of values, including, but not limited to, numeric values and/or alphanumeric values, points, levels, challenges, rewards, competition elements, etc. which may be made available at a client device for use by a user.

One or more operations and/or techniques disclosed herein may be implemented, in whole or in part, in connection with a client device that may include hardware, such as a display chip, graphics chip, or a combination thereof, to support a display coupled to the client device. In an implementation, a rewards system may be made available for user interaction on a graphical user interface (GUI), such as via a dashboard feature as part of a host application running on a client device and visible on a display.

A formal education at an educational institution (e.g., public, private, home school) may be the pathway to developing skills for entry into the workforce. Educational institutions typically, although not necessarily, may focus on common core subjects like math, science, reading, or the like. Although these or like subjects may be helpful to students as they grow, the typical educational institution may lack the resources to help students relate these disciplines to their future endeavors.

SATs and other forms of testing may provide some information about a student's performance in school but may not fully reflect a student's readiness for the job market. Although many schools may include career-readiness programs, these programs may not have kept up with technology. Further, some students may fail to utilize career services, workshops, or attending job fairs, etc. Indecision about career paths, due, for example, to students being unsure of their desired field or lacking the skills and knowledge to effectively identify suitable career options for their talents and skills, etc., may also have been observed in some cases. Procrastination on job applications may characterize some student behavior, such that the students may delay their job search or application process for relevant opportunities. For some students, career readiness may begin in late middle school or high school, making the concept foreign to students and giving them limited time to grasp and explore career options before making decisions about their future. These or similar challenges may impact many students at some stage in their future, including after graduation. How to improve or otherwise enhance the preparation work needed to help students enter the workforce continues to be an area of development.

An electronic infrastructure in the form of one or more digital signals received at a client device may provide interactive content to identify interests and skills of a student and help the student to connect to outside working world. Interactive content of an electronic infrastructure may provide the student with resources that fit their learning style and preferences. Interactive content may be adjusted in response to readiness of the student to begin interning or working.

An electronic infrastructure may, in whole or in part, make available a variety of processes for customers of the electronic infrastructure. In one implementation, a recruiting tool may enable a customer to collect, socialize and monetize student input that may be used, in whole or in part, to influence the curricular decisions of educators (on the student, teachers, guidance counselors, principals, and board members). This may include segmented trends based on, in whole or in part, student interests, scores, abilities, and activities in any given location across a geographic region (e.g., city, state, country). A recruiting tool of an electronic infrastructure may provide detailed reporting for job and college recruiters and scouts to better understand future trends.

An electronic infrastructure may, in whole or in part, make available an empowerment tool for customers of the electronic infrastructure. In one implementation, the empowerment tool may provide reviewing trends of a variety of criteria, such as schools, states, national, and industry trends. The empowerment tool may, in another implementation, provide a parent/guardian portal and/or a teacher portal to access features such as engagement metrics, recommended coursework, and report cards, to name a few.

Some example methods, apparatuses, or articles of manufacture are disclosed herein that may be implemented, in whole or in part, to facilitate or support one or more operations or techniques for implementing an electronic infrastructure for on-line learning, skills assessment, and/or recruiting, for example, that may be used, in whole or in part, in or with a client device, such as a mobile communication device. As a way of illustration, special purpose communication devices, which may herein be called simply client devices, may include, for example, cellular telephones, satellite telephones, smart telephones, personal digital assistants (PDAs), laptop computers, personal entertainment systems, tablet personal computers (PC), personal audio or video devices, personal navigation devices, or the like. It should be appreciated, however, that these are merely illustrative examples of client devices that may be utilized in connection with an electronic infrastructure for on-line learning, skills assessment, and/or recruiting app on the client device, and that claimed subject matter is not limited in this regard.

“Electronic content,” as the term may be used herein, should be interpreted broadly and refers to signals, such signal packets, for example, and/or states, such as physical states on a memory device, for example, but otherwise may be employed in a manner irrespective of format, such as any expression, representation, realization, and/or communication, for example. Content may comprise, for example, any information, knowledge, and/or experience, such as, again, in the form of signals and/or states, physical or otherwise. In this context, “electronic” or “on-line” content may refer to content in a form that although not necessarily capable of being perceived by a human, (e.g., via human senses, etc.) may nonetheless be transformed into a form capable of being so perceived, such as visually, haptically, and/or audibly, for example. Non-limiting examples may include text, audio, images, video, security parameters, combinations, or the like. Thus, content may be stored and/or transmitted electronically, such as before or after being perceived by human senses. In general, it may be understood that electronic content may be intended to be referenced in a particular discussion, although in the particular context, the term “content” may be employed for ease of discussion. Specific examples of content may include, for example, computer code, metadata, message, text, audio file, video file, data file, web page, or the like. Claimed subject matter is not intended to be limited to these particular examples, of course.

Thus, as will be described in greater detail below, in an implementation, an electronic infrastructure may be uploaded as an app in the form of one or more digital signals received at a client device, where the client device may be a mobile device or a laptop or desktop computing device, as non-limiting examples. An electronic infrastructure may include a registration feature that may be received in the form of one or more digital signals input to the client device. Also at the client device, a profile may be generated, based at least in part on the registration received thereon, where the profile, in one implementation, may be a user profile and, as may be shown and described in further detail herein, the user may be a student using an electronic infrastructure on the client device. At least in part based on the profile, an interactive content and a companion may be made available on the client device, wherein the companion may, in one implementation, be based on Artificial Intelligence. In some but not all instances, the companion may be generating and aggregating the interactive content on the client device. A value in the form of one or more digital signals may be generated on the client device, where the value may be based, at least in part, on the interactive content. The value may be made available by one or more additional processes available on the client device, such as but not limited to, a recruiting tool and an empowerment tool. The recruiting and empowerment tools may be based, at least in part, on multiple profiles of multiple users of an electronic infrastructure.

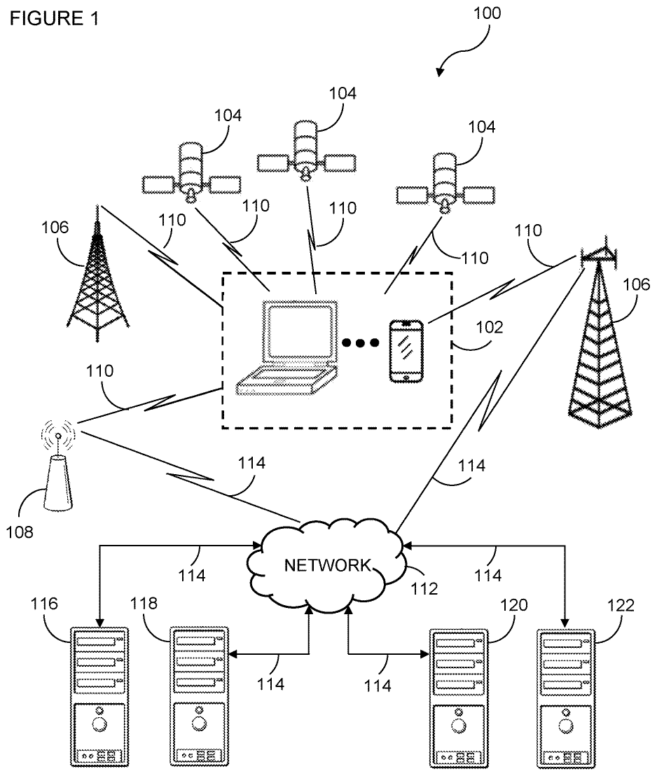

FIG. 1 is a schematic diagram illustrating features associated with an implementation of an example operating environment 100 capable of facilitating or supporting one or more processes or operations for implementing an electronic infrastructure for on-line learning, skills assessment, and/or recruiting, for example. It should be appreciated that operating environment 100 is described herein as a non-limiting example that may be implemented, in whole or in part, in the context of various communications networks or combination of networks, such as public networks (e.g., the Internet, the World Wide Web), private networks (e.g., intranets), wireless local area networks (WLAN, etc.), or the like.

As illustrated, operating environment 100 may comprise, for example, one or more satellites 104, base transceiver stations 106, wireless transmitters 108, etc. capable of communicating with a mobile device 102 via wireless communication links 110 in accordance with one or more communication protocols. Satellites 104 may be associated with one or more satellite positioning systems (SPS), such as, for example, the United States Global Positioning System (GPS), the Russian GLONASS system, the European Galileo system, as well as any system that may utilize satellites from a combination of satellite systems, or any satellite system developed in the future. Base transceiver stations 106, wireless transmitters 108, etc. may be of the same or similar type, for example, or may represent different types of devices, such as access points, radio beacons, cellular base stations, femtocells, or the like, depending on an implementation. At times, one or more wireless transmitters, such as wireless transmitters 108, for example, may be capable of transmitting as well as receiving wireless signals.

In some instances, one or more base transceiver stations 106, wireless transmitters 108, etc. may, for example, be operatively coupled to a network 112 that may comprise one or more wired or wireless communications or computing networks capable of providing suitable or desired information, such as via one or more communication links 114. As will be seen herein, information may include, for example, one or more digital signals indicating registration information received at client device, one or more digital signals generated via client device, and one or more digital signals made available to client device.

In an implementation, network 112 may be capable of facilitating or supporting communications between suitable computing platforms or devices, such as, for example, mobile device 102, one or more base transceiver stations 106, wireless transmitters 108, as well as one or more servers associated with operating environment 100. In some instances, servers may include, for example, an AI server 116, a cloud server 118, a backend server 120, as well as one or more other servers, indicated generally at 122 (e.g., navigation, information, map, etc. server, and so on), capable of facilitating or supporting one or more operations or processes associated with the operating environment 100.

As will be described in greater detail below, AI server 116 may provide a cloud-based AI service accessible through Application Programming Interfaces (APIs). The client device may send one or more digital signals, such as text, audio, or images, to AI server 116 using API calls. AI service may utilize trained machine learning models to process the one or more digital signals on AI server 116 and may send results back to an electronic infrastructure app on a client device.

In an implementation, information sent to AI server 116 by an electronic infrastructure may be limited to non-sensitive, non-private information. Accordingly, electronic infrastructure may also have an embedded AI service to process sensitive information. An electronic infrastructure thus may support a hybrid approach to using Artificial Intelligence to maintain privacy of sensitive information.

In an implementation, cloud server 118 may be used, in whole or in part, to store one or more databases of information used, in whole or in part, by a client device implementing the electronic infrastructure app. As with the AI server 116, cloud server may be accessed using APIs to send or fetch records. An electronic infrastructure on client device may also include local storage, such as to cache records, for example. In an implementation, cloud server 118 may include security, such as authentication, to maintain data privacy.

In an implementation, backend server 120 may be the server infrastructure for an electronic infrastructure on client device. An electronic infrastructure app may be accessible from a web site client device (web app), part of a mobile application client device (mobile app), such as mobile device 102, or both. Backend server 120 may provide a shared architecture to maintain consistency across platforms. In an implementation, mobile app may send a request to backend server 120 using APIs while web app may send requests through a browser using HTTP or WebSocket requests. Backend server 120 may also feature a database or may use a database of cloud server 118. In one implementation, web app client device and mobile app client device may share a common login, so the same credentials, in whole or in part, may be used, in whole or in part, to authenticate a user on backend server 120. In some instances, this architecture or like architecture may be implemented, in whole or in part, to ensure that information and functionality may be the same across web site client device and mobile application client device, such that users may switch seamlessly between devices.

Even though a certain number of computing platforms or devices may be illustrated herein, any number of suitable computing platforms or devices may be implemented, in whole or in part, to facilitate or otherwise support one or more techniques or processes associated with operating environment 100. For example, at times, network 112 may be coupled to one or more wired or wireless communications networks (e.g., Wi-Fi, etc.) to enhance a coverage area for communications with mobile device 102, one or more base transceiver stations 106, wireless transmitters 108, servers 116, 118, 120, 122, or the like. In some instances, network 112 may facilitate or support femtocell-based operative regions of coverage, for example. Again, these are merely example implementations, and claimed subject matter is not limited in this regard.

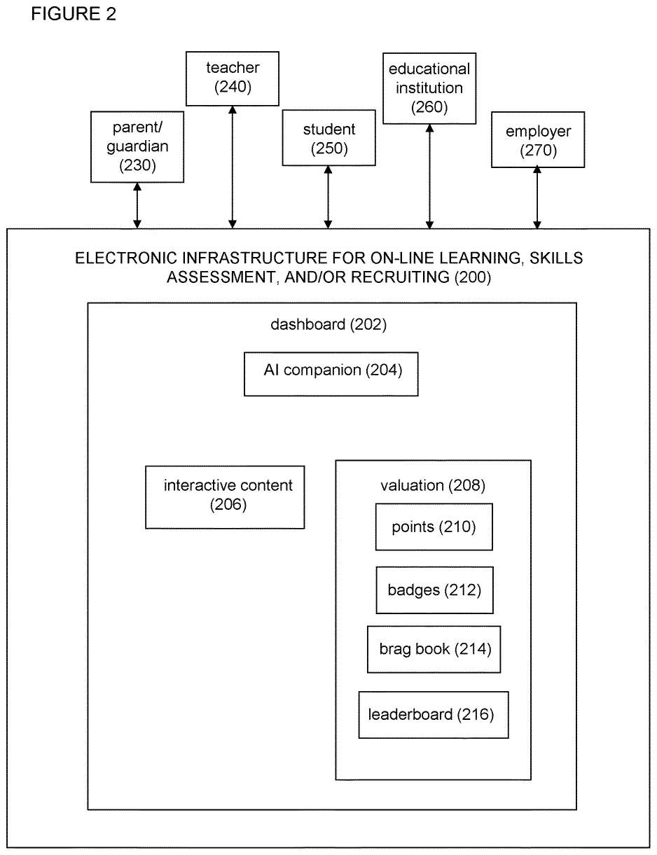

FIG. 2 is a schematic representation illustrating, at least in part, example components of an electronic infrastructure for on-line learning, skills assessment, and/or recruiting 200 (also known herein as “electronic infrastructure 200” or “infrastructure 200”), according to an implementation. As discussed below, in some instances, these or like one or more operations and/or techniques may be implemented, in whole or in part, to facilitate and/or support an electronic infrastructure 200 using a mobile app on a client device, such as via a mobile device such as a smart phone, tablet, or smart watch, or using a web app on a client device, such as from a laptop or desktop computing device.

In one implementation, an electronic infrastructure 200 may be accessed by a user, such as a student 250, shown at the top of FIG. 2. Although an electronic infrastructure 200 may, in some instances, be used, in whole or in part, in other learning contexts, the electronic infrastructure 200 may be described hereinafter with respect to students in the kindergarten through twelfth grade (K-12). In one implementation, an electronic infrastructure 200 may be used, in whole or in part, by a student 250 from kindergarten through their entire time in secondary school, although some students may start using the infrastructure when they are older.

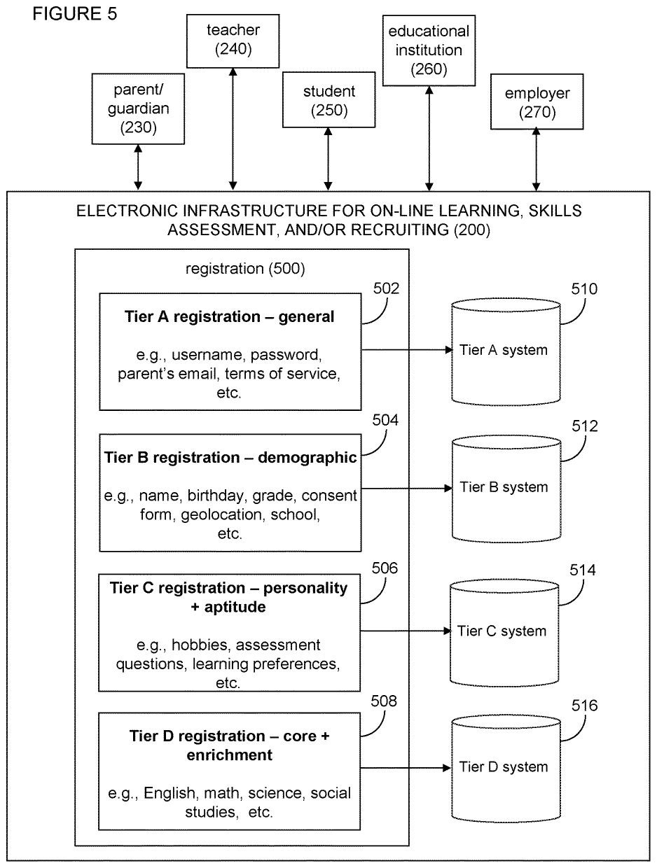

Upon registration by a student 250 into the electronic infrastructure 200 (discussed in FIG. 5), a dashboard 202 may become visible. A dashboard 202 may be a visual display interface of an electronic infrastructure 200 and may, in one implementation, include, among other things, features to facilitate learning about the world of work from a philosophical and exploratory standpoint. In an implementation, the appearance of a dashboard 202 may change, in whole or in part, based on who may be logged onto the electronic infrastructure 200 app. Thus, a dashboard 202 may have a first presentation to a student 250 (and their parent/guardian 230) while, to other entities logging into the electronic infrastructure 200, the dashboard 202 may have a second presentation, the second presentation being, at least in some aspects, different from the first presentation.

From the registration information provided by a student 250, an AI-accountability buddy, known herein as an AI companion 204, or simply “companion” may be generated. The AI companion 204 may be designed to grow physically and mentally with a student 250 based on input received as a student 250 explores an electronic infrastructure 200, which may include, but is not limited to, registration information (see, e.g., FIG. 5, below). An AI companion 204 may be, in one implementation, a vehicle through which a student 250 accesses other features of the electronic infrastructure 200.

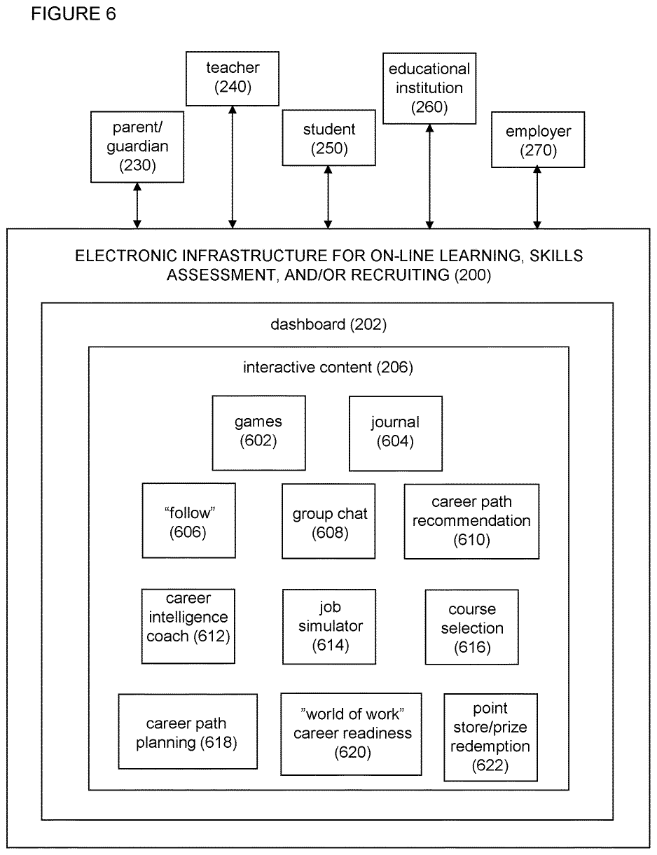

The dashboard 202 may comprise, in whole or in part, features visible to the student 250 to facilitate growth and learning. In an implementation, interactive content 206 may be routinely presented by the AI companion 204 for a student 250 to access. In one implementation, the interactive content 206 may include a variety of selectable activities and/or features visible on the dashboard 202. The interactive content 206 of an electronic infrastructure 200 is described in more detail in FIG. 6.

In an implementation, an electronic infrastructure 200 may also comprise valuation 208 which may be visible on the dashboard. Valuation 208 may include, but is not limited to, points 210, badges 212, a brag book 214, and a leaderboard 216. Students 250 using an electronic infrastructure 200 may be rewarded with valuation 208, such as points 210 and badges 212, based on completion of interactive content 206, which, in an implementation, may be suggested to them by the AI companion 204 or performed on their own initiative. In an implementation, points 210 may be issued for each interactive content 206 completed by a student 250 while badges 212 may be issued periodically, such as every year, every semester, or every quarter, or may be based on point-based milestones achieved.

In an implementation, the dashboard 202 may further comprise a brag book 214. The AI companion 204 may let a student 250 know, for example, that they scored the highest score on an interactive content 206, such as a game, after which the AI companion 204 may automatically add the milestone and other student achievements to the brag book 214. The brag book 214 may at times be a mechanism for tracking milestones of a student 250 who may use an electronic infrastructure 200 and may further be used for scouting considerations by educational institutions 260 and employers 270.

In one implementation, a leaderboard 216 may be displayed on the dashboard 202 of the electronic infrastructure 200. A leaderboard may be a visual representation that may display the performance of people or teams involved in a competitive environment, often in the form of a ranked list. A leaderboard 216 may indicate to a student 250 their place among peers in a particular game or activity performed using the electronic infrastructure 200. A leaderboard 220 thus may invoke a competitive spirit into the learning process.

An electronic infrastructure 200 has thus far been described with respect to a student 250 using the infrastructure. Student 250 may provide input to an electronic infrastructure 200, through use of dashboard 202 elements and registration (discussed further in FIG. 5), and, in one or more implementations, may receive information by learning about career paths, the world of work, the nomenclature of the workplace environment, and so on.

There may be other users, however, that may, in whole or in part, benefit from an electronic infrastructure 200 as well. Shown at the top of FIG. 2 along with a student 250, a parent/guardian 230, a teacher 240 (which may also include relevant staff, such as, for example, a principal), an educational institution 260 (which may be further divided into primary decision makers, secondary decision makers, and higher education decision makes, such as colleges and universities), and an employer 270 may also be users of an electronic infrastructure 200 and may benefit by using or accessing an electronic infrastructure 200, as described herein.

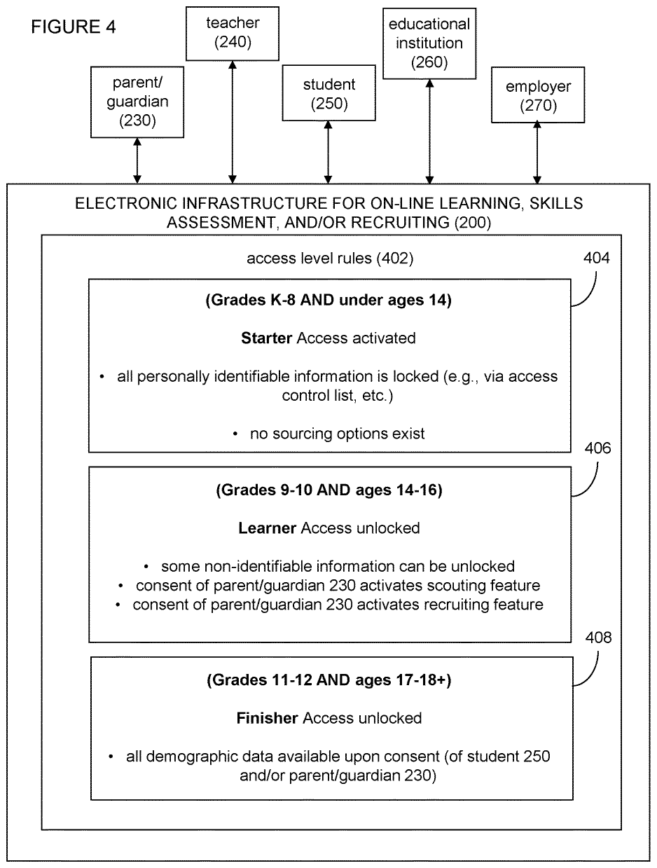

An electronic infrastructure 200, in one implementation, may divide students into different categories based on their age to control access by a parent/guardian 230, teacher 240, educational institution 260, and/or employer 270. Access level rules of an electronic infrastructure 200 are described in detail in FIG. 4.

For a younger students, a parent/guardian 230 may, in an implementation, assist with registration of a student 250 and may further monitor progress of the student 250 over the course of using, in whole or in part, an electronic infrastructure 200, which may occur over many years.

In an implementation, a teacher 240 may use an electronic infrastructure 200 in several ways which may, although not necessarily, inure to the benefit of the student 250. A teacher 240 may, for example, reinforce engagement with a student 250 by assigning homework and check-ins at a regular cadence while also discussing and aligning some of the content to which the student 250 may have been exposed in an electronic infrastructure 200 at a high level in the classroom. Using an electronic infrastructure 200, the teacher 240 may, though not necessarily, engage more deeply with a student 250 and their parent/guardian 230 by tracking student progress, identifying trends, and reinforcing interests in the classroom. In one implementation, a teacher 240, by regularly consulting an electronic infrastructure 200, may identify and nurture talent and may identify whether the student needs extra care, support, or accommodations based on learning styles and other factors. An electronic infrastructure 200, in one implementation, may also be used, in whole or in part, by the teacher 240 to tailor activities, course selections, and classroom discussions based on classroom-wide trends and interests. A teacher 240 may, in some instances, assess classroom-wide trends by consulting an electronic infrastructure 200, not just to evaluate the student, but to also evaluate other students within their class who may be using the electronic infrastructure 200.

An educational institution 260 may, in an implementation, see early talent trends and may send interview invitations through an electronic infrastructure 200. Invitations may be sent by an educational institution 260 to older students, as one example. Further, in an implementation, electronic infrastructure 200 may be designed, in whole or in part, to be safe and secure so that only educational institutions 260 that have access to the electronic infrastructure may be able to court the student 250.

An educational institution 260 may, in an implementation, be able to identify and source candidates from the students using an electronic infrastructure 200 for internships and entry-level jobs. Using an electronic infrastructure 200, an educational institution 260 may ascertain, in whole or in part, how the future of work may be trending, such that a monetized annual Future of Work report may be produced. An electronic infrastructure 200 may show an educational institution 260, for example, about learning capabilities of a student 250, including, but not limited to, their interests and skills, as well as what keeps them engaged outside of the classroom or with a certain subject.

An employer 270 may, for example, see early talent trends and may send internship invitations through an electronic infrastructure 200 which, in one implementation, may be safe and secure. As one example, the invitations may be made available to students of a certain age, e.g., 16 and older. An employer 270 may identify and source candidate students for internships and entry-level jobs using, for example, an electronic infrastructure 200. By utilizing an electronic infrastructure 200, the employer 270 may understand how the future of work may be trending and produce a monetized annual Future of Work report, much like the example capability of an educational institution 260. An employer 270 may also pay to run safe search reports through the school using an electronic infrastructure 200, in one implementation.

The goals of an electronic infrastructure 200 may include, but are not limited to, empowering students to discover their gifts and using them to find their purpose when they graduate high school, facilitating teacher and parent/guardian engagement with the student on their learning journey, informing the world of work through safe, exclusive, and unique information and reporting, and informing the world of education through safe, exclusive, and unique methods to course selection, recruiting, and operations.

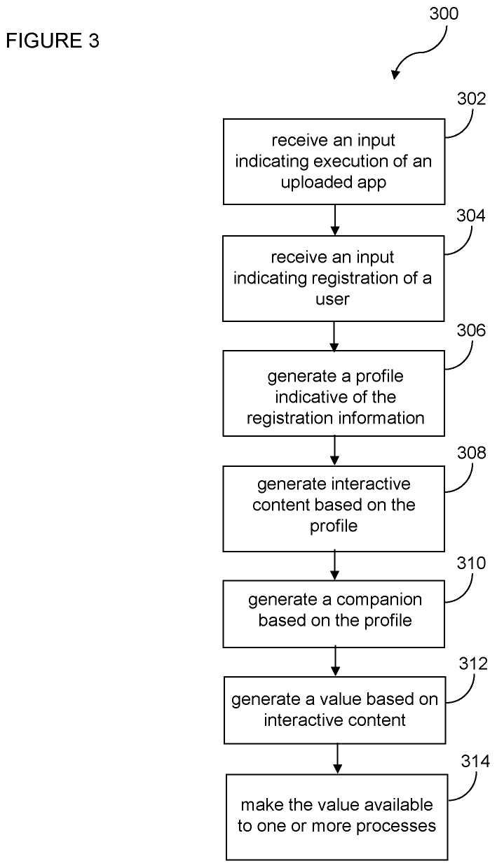

FIG. 3 is a process flow showing, at least in part, operations 300 performed by an electronic infrastructure for on-line learning, skills assessment, and/or recruiting 200 on an operating environment, such as the operating environment 100 of FIG. 1, according to an implementation. The operations 300 of an electronic infrastructure 200 may include receipt of an input indicating execution of an uploaded app (block 302), followed by receipt of an input indicating registration of a user, such as student 250 (block 304). In on implementation, registration may provide an electronic infrastructure 200 with information about the student 250, which may include, but is not limited to, general, demographic, personality and aptitude, and core and enrichment information, or the like. The registration performed by the student 250 in one implementation of an electronic infrastructure 200 is described in detail in FIG. 5.

A profile of the student 250 indicative in one example of the registration provided by the student, may be generated (block 306). The profile, which may also be described herein as a student profile or an electronic profile, may be stored in a database, such as on cloud server 118, or may be stored on one or more other servers, such as AI server 116, backend server 120, one or more servers 122 (FIG. 1), or may be stored locally on client device. In one implementation, a student-specific companion indicative of the registration may be generated (block 308), e.g., the AI companion 204 (FIG. 2).

Interactive content based on the profile may, in an implementation, be generated (block 310). Interactive content may be generated by an AI companion 204, for example. As is shown and described herein, interactive content may enable student 250 to engage with an electronic infrastructure 200, such as, in one example, by playing games on client device. Based on the interactive content, a value may be generated (block 312). In an implementation, the value may be made available to one or more processes (block 314).

FIG. 4 is a schematic representation featuring a set of access level rules 402 of an electronic infrastructure 200, according to an implementation. Students using an electronic infrastructure 200 may be divided into three categories: starters (kindergarten-8th grade), learners (9th and 10th grades), and finishers (11th and 12th grades). In an implementation, an electronic infrastructure 200 may be tailored, in whole or in part, using AI companion 204, to support the disparate needs and characteristics of the starter, learner, and finisher students. This personalized approach may, for example, ensure that a student 250 may be well-versed in the particulars of the workforce well before entering high school.

Access level rules 402 of an electronic infrastructure 200 may be promulgated with these categories in mind. In one implementation, access level rules 402 may comprise starter access rules 404, learner access rules 406, and finisher access rules 408. Access rules 402 may be implemented, in whole or in part, for example, for the safety and security of each student 250 using electronic infrastructure 200.

In one implementation, for kindergarten through 8th grade (and under age 14), starter access may be activated. Starter access rules 404 may indicate, for example, that personally identifiable information of student 250 may be locked (e.g., via access control list, etc.), with no sourcing options existing. Assuming Tiers A and B registration rules are in place, employers 270 and educational institutions 260, such as universities and colleges, may sue sourcing to express interest in a student 250 by creating a pipeline/short list of talent they are interested in contacting.

In one implementation, for grades 9-10 and ages 14-16, learner access may be unlocked. Learner access rules 406 may, for example, indicate that some non-identifiable and/or identifiable information may be unlocked. Further, in one implementation, scouting and/or recruiting features of electronic infrastructure 200 may be activated with the consent of a parental/guardian 230.

As used herein, scouting may be the process of observing and evaluating a prospect, over time, with the intention of perhaps having the prospect become part of an organization. An educational institution 260 may scout a student 250, for example, in the hopes that they may become part of their college or university in the future. Similarly, an employer 270 may scout a student 250 for a future internship or offer of employment with their company. As used herein, recruiting may be the process of engaging with a prospect to build a relationship, with the intent, in whole or in part, that the prospect may become part of their organization. Scouting may typically occur before recruiting. Although students in the learner group may not be ready for recruitment, scouting may be appropriate for this age group in some cases.

In an implementation, learner-level information may be unlocked upon receiving consent of a parent/guardian 230. This allows for a lighter level of engagement, for example, with educational institutions 260 and employers 270 and the chance to start communications regarding internship opportunities that may be typically available for finisher students. Qualifying student information may, for example, appear in search results, and may provide viewing and engagement opportunities for educational institutions 260 and employers 270.

For grades 11-12 and ages 17-18 and above, finisher access level may be activated, in one implementation. Demographic information of a student 250 may be unlocked and available once consent of a student 250 and/or parent/guardian 230 may be received by the electronic infrastructure 200. In a non-limiting example, historic data for a student 250 may become available, such as to provide a holistic look at progress/skills, etc.

FIG. 5 is a simplified schematic representation of a registration process 500 of an electronic infrastructure 200, according to an implementation. Introduced in FIG. 3 (block 304), registration may be a four-part process, in one implementation, and may be denoted Tier A registration 502, Tier B registration 504, Tier C registration 506, and Tier D registration 508, and the four parts may be completed, in whole or in part, by each student 250. For the registration tiers, there may be input fields to be completed (e.g., student name) and/or self-selection/choice-based questions (e.g., student age).

In an implementation, the information obtained from each tier of registration may be separately stored, such as in separate databases. Tier A registration 502, for example, may be stored in database 510 as Tier A system, Tier B registration 504, for example, may be stored in database 512 as Tier B system, Tier C registration 506, for example, may be stored in database 514 as Tier C system, and Tier D registration 508, for example, may be stored in database 516 as Tier D system. The databases 510, 512, 514, and 516 may be part of the cloud server 118, the backend server 120, or be in some other location. In one implementation, separation of the registration information into separate databases may enable control of sensitive student information.

Tier A registration 502 may be, for example, a general registration part in which a student 250 and/or parent/guardian 230 may enter basic information. The general registration information may include, but is not limited to, a username and password created by a student 250 and/or parent/guardian 230, an email address of a student's parent/guardian, and a terms of service notice (to be electronically signed by a student or parent/guardian, depending on the student's age).

For student privacy, in one implementation, a username of a student 250, not the student's actual name, may be visible on a dashboard 202 of an electronic infrastructure 200. A parent/guardian 230 email address may ensure transparency, for example, and may enable the parent/guardian to monitor a student 250 as they navigate the electronic infrastructure 200. This may also encourage involvement by the parent/guardian 230, for example, as the student 250 may use the electronic infrastructure 200. The username, for example, may ensure anonymity of a student 250 so that educational institutions 260 and employers 270 do not have access to their information.

With Tier A registration 502, sensitive information of a student 250 may, in one implementation, be captured in the Tier A system (database 510) and handled through a gated onboarding process. In an implementation, an electronic infrastructure 200 may reference COPPA (Children's Online Privacy Protection Act) in fashioning its gated onboarding process. In an implementation, authorized students may gain consent with the signature of a parent/guardian 230 at a gate. Once consent may be given, information may be stored and then transferred to the Tier B system 512 of electronic infrastructure 200.

In an implementation, an electronic infrastructure 200 may follow a set of age-specific access level rules 402 (FIG. 4) that may determine the access levels and information visible when customers (e.g., educational institutions 260, employers 270) may be sourcing on the business-to-business side of an electronic infrastructure 200.

In an implementation, login credentials may be used, in whole or in part, to gain access to the electronic infrastructure 200 from other devices. For security, a student 250 may, for example, need to log out of an electronic infrastructure 200 app on their mobile device before logging in on another device, such as a tablet or a laptop, and vice-versa. The username of a student 250 thus may help an electronic infrastructure 200, for example, to differentiate between profiles that may be created and may identify the student 250 as the holder of the profile. In one implementation, a username may be associated with the email address of a parent/guardian 230 for communications, alerts, and to monitor access (e.g., student's engagement, upgrading opportunities, scouting requests, etc.).

Tier B registration 504, demographic registration, may be an opportunity for the electronic infrastructure 200 to receive additional information about the student 250. Tier B registration 504 may include, but is not limited to, a student's name, the birthday, grade, school, and geolocation of a student 250, as well as a consent form signed by the student or parent/guardian 230, in one implementation.

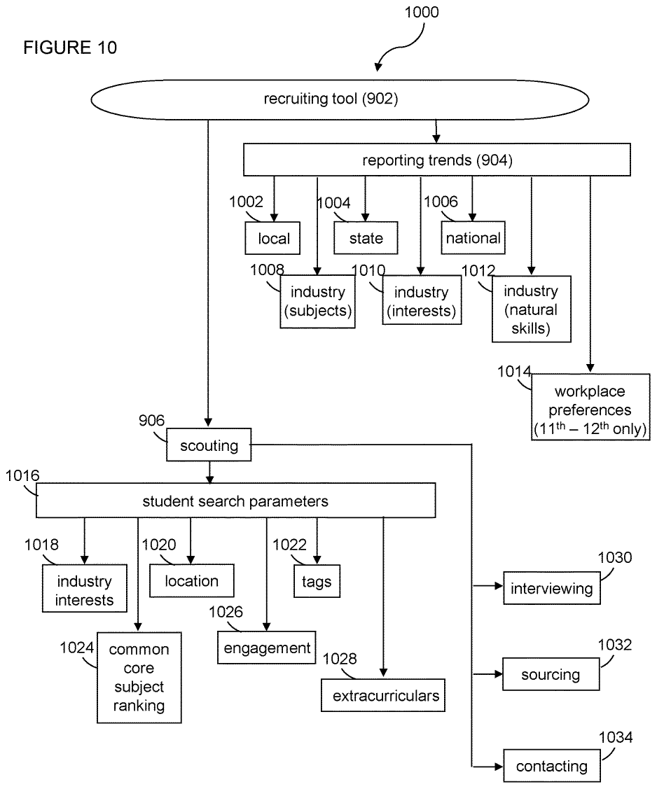

With Tier B registration 504, information received from a student 250 may, for example, be compressed and then transferred and/or made available to suitable systems, such as to the Tier B system (database 512) where in an implementation a set of rules may be followed. These rules may be designed, for example, to ensure the safety of a student 250 and the anonymity and fairness in the recruiting and scouting process. The recruiting and scouting processes of the electronic infrastructure 200 are described in FIG. 10.

In an implementation, an electronic infrastructure 200 may handle information sensitivity by, in whole or in part, building parameters around certain permissions and features. Sourcing and scouting functions, for example, may, in whole or in part, be available at certain grade levels. Student input may be generated by a built-in guardian consent form (with security measures, such as Captchaa*, for example). In response to a student 250 passing one or more gated consent screens, some information may be revealed to customers who may be sourcing for internships and job opportunities. For example, location services may be unlocked, such that a customer search filter may start within a predetermined distance radius (e.g., 20 miles) for safety reasons. In an implementation, an electronic infrastructure 200 may keep track of time and automatically increases the age of a student 250 each year.

Tier C registration 506, which, in one implementation, may pertain to personality and aptitude of a student 250, may obtain hobbies of a student 250, may determine learning preferences of the student, may ask assessment questions of the student, etc., which may help the AI companion 204 to understand more about the student 250. Information received from a student 250 at Tier C registration 506 may be compressed and then transferred and/or made available to suitable systems, such as the Tier C system (database 514).

Tier D registration 508, in one implementation, may obtain core plus enrichment information of a student 250, such as, but not limited to, English, math, science, social studies, etc., coursework of the student 250. Courses taken by the student 250, as well as their grades may be obtained. This information may help the AI companion 204 to know the types of interactive content 206 with which to engage a student 250.

With tier D registration 508, student grade actuals and student subject preferences provided by a student 250 may be collected following a gated process, e.g., via a guardian/parent consent form, fingerprint feature, and/or stylus signature, as examples. Core plus enrichment actuals and preferences of a student 250 may be stored in database 516.

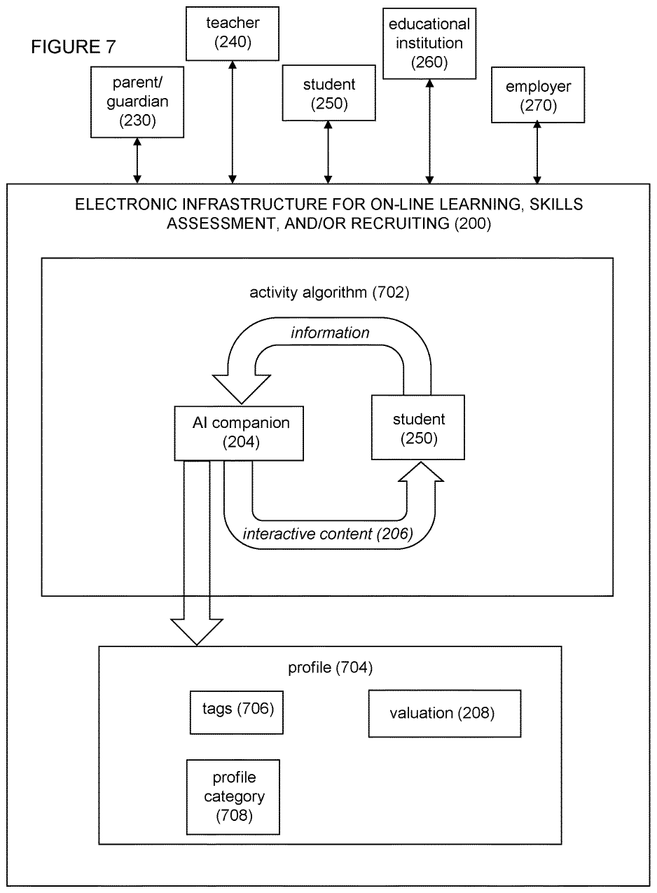

In an implementation, the electronic infrastructure 200 may assign a profile type to each student 250 based on responses given in the Tier C and Tier D registration 508. The student profile and profile category are described in FIG. 7. An electronic infrastructure 200 may, in one implementation, score, compress, and transfer information to an AI companion 204. An AI companion 204 may recommend interactive content 206 based on comprehension and grade level of a student 250, as well as their learning and activity preferences, for example. In an implementation, an electronic infrastructure 200 may prompt the Tier C and D registrations 506 and 508 to be re-processed at periodic time intervals, such as, for example, every 45 weeks. In an implementation, Tier A system 510 and Tier B system 512 may determine overall access levels (e.g., starter 404, learner 406, and finisher 408 in FIG. 4) of a user while Tier C system 514 and Tier D system 516 may be unlocked at any access level.

FIG. 6 is a simplified schematic representation of an electronic infrastructure for on-line learning, skills assessment, and/or recruiting 200 in which interactive content 206 introduced in FIG. 2 are described in more detail. Interactive content 206 illustrated herein may include, but is not limited to, games 602, a journal 604, a “follow” function 606, a group chat 608, a career path recommendation function 610, a career intelligence coach 612, a job simulator 614, a course selection function 616, a “world of work” career readiness function 618, a point store/prize redemption function 620, and a career path planning function 622, to name a few.

In one implementation, the interactive content 206 may comprise a variety of games 602, one or more of which may be AI-powered. The games 602, for example, may encourage a student 250 to engage with an electronic infrastructure 200 as well as provide challenges that help the student grow. The games 602 may be issued by the AI companion 204, may be available on the dashboard 202 for a student 250 to access without prompting by the AI companion 204, and so on. In one implementation, the games 602 may be tailored, with or without the assistance of a companion, such as an AI companion 204, to suit the learning style and/or preferences and behavioral patterns of a student 250. For example, one or more of the games 602 may include age-appropriate career-related subjects, such that a world beyond school may be introduced to even very young students. Games 602 may include, but are not limited to, puzzles, word games, science games, trade games, typing games, daily challenges, art games, simulation (e.g., Owlchemy Labs), math games, and history games. In an implementation, games 208 include audio, video, and/or written articles about the topics of interest.

In an implementation, games 602 may include daily challenges that may encourage a student 250 to regularly access the electronic infrastructure 200. Although denoted “daily” games, these challenges may additionally or instead be weekly, monthly, weekend challenges, those that happen every holiday, special “bonus” challenges offered to a student 250 on their birthday, etc.

On the dashboard 202, the student 250 may also access a journal 604. In one implementation, an AI companion 204, for example, may prompt the student to “write about your day” in the journal 604. In addition to valuation 208 introduced in FIG. 2, such as points 210, badges 212, brag book 214, and leaderboard 216, a journal 604 may, for example, encourage a student 250 to acknowledge their progress in a meaningful way. Journaling has been shown to build writing and storytelling in students and thus may serve a dual purpose of encouragement and skill development.

Interactive content 206 may also comprise a “follow” function 606 to, in one or more implementations, allow a parent/guardian 230, teacher 240, educational institution 260, and/or employer 270 of the electronic infrastructure 200 to track progress of the student 250 (where the student may be anonymous). The dashboard 202 may, for example, have a selectable “follow” button to initiate the “follow” function 606 of an interactive content 206. The “follow” feature 602 thus may allow users of the electronic infrastructure 200 to maintain visibility of the student 250 for future opportunities, such as scouting and recruiting. The scouting and recruiting functions of the electronic infrastructure 200 are described in FIG. 10.

Interactive content 206 may also comprise a group chat function 608. This social component of an electronic infrastructure 200 may, in one implementation, allow a student 250 to engage with friends and peers, including those not geographically proximate to the student. An electronic infrastructure 200 may enable a student 250 to meet with a like-minded student or join an industry-focused chatroom of multiple students.

In an implementation, AI-generated discussion questions and recommendations may be issued to a student 250 and, based on the answers given, an electronic profile of the student may be updated. An electronic infrastructure 200 may, for example, recognize similar electronic profiles of other students using the electronic infrastructure, thus enabling, in an example, those students in a group chat function 608. In an implementation, a group chat function 608 may be secured and limited, based in part on the age of the student 250.

Interactive content 206 may further include a career path recommendation function 610. In high school (learner and finisher), the AI companion 204 may, in one implementation, begin to recommend if college, certification, vocational, or straight-to-work paths may be appropriate for a student 250, particularly, in some examples, those students who may be uncertain. An electronic infrastructure 200 may compress an interactive content 206 to determine the recommendation. In one implementation of a career path recommendation function 610, a student 250 may be encouraged to perform activities to determine whether they will be college bound, receiving a certification/apprenticeship in a skilled trade (e.g., electrician, carpenter, plumber, IT, healthcare), and so on.

Interactive content 206 may also comprise a career intelligence coach 612. In one implementation, a career intelligence coach 612 may be a role taken on by an AI companion 204 to engage a student 250 about the world beyond their schooling. An AI companion 204 may encourage a student 250 to ask about career questions and obtain advice. In an implementation, an AI companion 204, in its role as career intelligence coach 612, may compress and transfer information, such as the tiered onboarding details described in registration operations of FIG. 4, plus engagement and other behaviors, and, for example, may shift the AI companion 204 from making recommendations to coaching and guidance.

A starter student may, for example, ask about what it takes to be a fireman or an astronaut. A career intelligence coach 612 may provide age-appropriate answers to guide the student, e.g., “a fireman needs to have a healthy diet, work well as a team, and be strong” while “an astronaut needs to be pretty good at math and science” may be example answers a career intelligence coach 612 may provide. A learner student may ask about being an astronomer or a civil servant and the finisher student may ask what civil servant jobs provide pensions and how many years of math and physics may be required for a career in astronomy. A career intelligence coach 612 may also ask, “how do you think your current skills match with your career goals?” and “what would you need to do more of to reach your goals?”.

In a non-limiting example, an interaction between student 250 and career intelligence coach (CIC) 612 may be conversational in nature and tailored to the level of the student. A starter student interaction may be something like: Student (starter): “I want to be a teacher.” CIC: “That's so exciting! Why do you want to be a teacher?”. A learner student interaction may be something like: Student (learner): “What does a teacher do?” CIC: “A teacher creates and assigns activities to help students learn. Is this something you want to do?”. A finisher student interaction may be something like: Student (finisher): “What do I need to do to become a teacher?” CIC: “You will need a bachelor's degree, A State Certification and Training/Classroom hours. Which colleges/universities interest you most, so we can tackle the first requirement?”. These are merely example conversations intended to show that the career intelligence coach 612 may tailor their conversation with student 250 based on their starter, learner, or finisher status.

Regular use of a career intelligence coach 612 over the course of the student's childhood may, in one implementation, provide a depth of understanding not heretofore possible in education.

Interactive content 206 may also comprise a job simulator 614. In one implementation, a job simulator 614 may partner applications to practice roles. A job simulator 614, which may or may not be via an AI companion 204, may be implemented, in whole or in part, to recognize potential job interests of a student 250 based on their profile, and may recommend an appropriate simulator app for the student 250. Within an electronic infrastructure 200, student 250 may enter a “job world”, and may, for example, experience a day in the life of particular roles (e.g., scientist mixing together chemicals, a teacher assigning and checking homework of students, and so on).

Interactive content 206 may also comprise a course selection function 616, such as to help a student 250 with picking courses that fit with their stated career plans, and the interactive content 206 may also feature a career path planning function 618 for those students who have some certainty about the career path they want to take. In an example implementation, career path recommendation 614 and career path planning 618 start at the learner level of student 250. Career path recommendation 614 may, for example, include strategic milestones taken to get to roles on a career path. Using the example of a teacher, strategic milestones may include 1) go to college to obtain a bachelor's degree, 2) obtain a state certification, 3) complete x hours of training/internship, and 4) become a teacher, while career path planning 618 may be, for learner student, 1) start researching colleges that specialize in education and find five schools you like, 2) talk to your guardians and guidance counselor about these options and 3) complete a teacher job simulation game by some time frame (e.g., end of the year). For a finisher student, career path planning 618 may be, 1) apply to five colleges you like, 2) prepare for interviews, 3) research state certifications following coursework, 4) schedule time with adviser to discuss post-graduation internships. These are merely example illustrations of how the career path recommendations 614 and career path planning 618 may be implemented in an electronic infrastructure 200 and are not meant to be limiting.

Interactive content 206 may also comprise a “world of work” career readiness function 620. In one implementation, a “world of work” career readiness function 620 may be a set of gamified learning modules that allow a student 250 to become “certified” in career readiness once they have completed high school. A “world of work” career readiness function 620 may, for example, include a career readiness content package with information and recommendations on how to navigate a job search, as well as exploring different workplace dynamics. A student 250 using a “world of work” career readiness function 620 may be exposed to workplace subjects, for example, as well as experience age-appropriate questions: “what is a career?”, “what is professionalism?”, “What does the HR team do?”, and so on, with these merely being non-limiting examples of questions that may be posed.

In an implementation, a student 250 may receive a badge 212 (FIG. 2) for completing learning modules received from a “world of work” career readiness function 620, and points 210 (FIG. 2) may additionally being given for completing the module before some predetermined time expires, as examples in which valuation 208 may be used, in whole or in part. While a student 250 may be playing games, assessments may be made and milestones may be accrued, for example, in a “world of work” career readiness function 620, such that, in an implementation, the student 250 may be learning along the way. Periodic badges 212 may, for example, denote a level of professionalism and show that progression may be made by a student 250.

Interactive content 206 may also comprise a point store/prize redemption function 622. Recall from FIG. 2 that valuation 204 includes, among other aspects, points 210. A point store/prize redemption function 622 may, in one implementation, provide a means with which a student 250 may use points 210 to purchase items. A student 250 may use the point store/prize redemption function 622 to redeem accrued points 210. In an implementation, the point store/prize redemption function 622 may be connected to other facilities/websites, such as the Amazon (Target, Walmart, Home Depot, Costco, etc.) store, the App store, or a gift card repository. Points 210 may, in other implementations, be redeemed in other ways, including, but not limited to, being applied toward university/college admission costs, redemption at the university/college gift store, or donation to a cause by a student 250.

FIG. 7 is a schematic representation showing additional aspects of an electronic infrastructure 200, according to an implementation. A relationship in one or more implementations between a companion, such as an AI companion 204 and a student 250 has already been described. An activity algorithm 702 may be implemented, in whole or in part, such that an AI companion 204 may be providing interactive content 206 to a student 250 and may be further receiving information, such as in the form of completion of interactive content, from the student. In one implementation an AI companion 204 may update a profile 704 based, in whole or in part, on the information received from a student 250. In one implementation, each student using an electronic infrastructure 200 may have their own unique profile.

In an implementation, a profile 704 may be a dynamic reflection of how a student 250 performs using an electronic infrastructure 200. A profile 704 may be constantly updated, for example, as a student 250 engages with interactive content 206 of an electronic infrastructure 200. A profile 704, in one implementation, may feature elements to help an electronic infrastructure 200 characterize a student 250. In an implementation, a profile 704 may include one or more of tags 706, a profile category 708, which may be defined by industry-related interests determined by interactive content 206 infrastructure, and valuation 208 (FIG. 2). In an implementation, components of a profile 704 may not be visible on a dashboard 202, except for one or more valuation 208 elements, such as points 210, badges 212, brag book 214, and leaderboard 216.

In an implementation, tags 706 of a profile 704 may be, for example, information about interests of a student 250. Examples of tags 706 that may be used, in whole or in part, in an electronic infrastructure 200 may include, but are not limited to, engineering, math, sports, artistic, theatre, and so on. The list of tags 706 may be quite long, in on implementation, with new tag categories being defined on an ongoing basis, for example. Tags 706 may be industry relevant, such as if a student 250 expresses interest in a particular industry and received points 210 from content related to that industry.

In an implementation, a profile category 708 of the profile 704 may be assigned based on the student information to match specific industries designated by suitable values. A profile category 708 may, for example, result from a combination of industry, interests, and common core ranking of a student 250, and may be stored in a database of an electronic infrastructure 200.

In an implementation, valuation 208 of a profile 704 may change every time a student 250 may accrue points 210 or may have points deducted, may receive a badge 212, may obtain an entry in a brag book 214, may be celebrated on a leaderboard 216, and so on, as these are meant to be non-limiting examples. Though part of a profile 704, in one implementation, one or more aspects of a valuation 208 may also be visible to a student 250, such as on a dashboard 202.

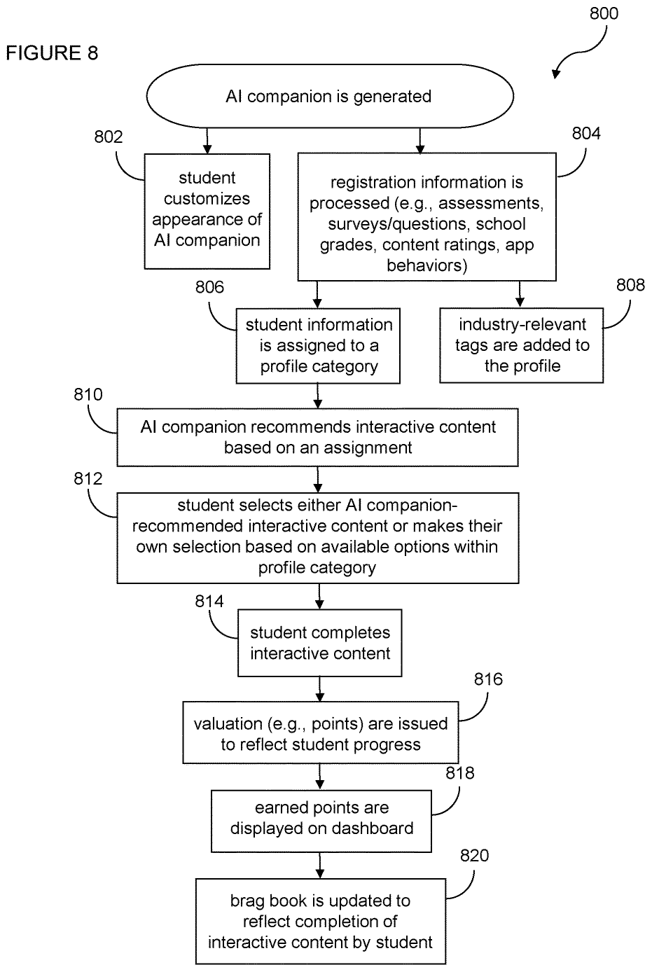

FIG. 8 is a process flow of an electronic infrastructure 200, according to an implementation. Once a companion, such as an AI companion 204, may be generated, a student 250 may customize the appearance of the AI companion 204 (block 802), and the AI companion 204 may thereafter appear on a dashboard 202 of the electronic infrastructure 200. In one implementation, an AI companion 204 may grow physically and mentally with a student 250, such as, for example, using memory, educated guesses based on trends, behaviors, etc. Periodically, such as at the beginning of the school year or semester, for example, a student 250 may provide new and/or additional information to an electronic infrastructure 200, which, in one implementation, may enable growth of the AI companion 204.

In one implementation, registration information of a student 250 may be processed by the electronic infrastructure 200 (block 804). The information may include, for example, but is not limited to, assessments, surveys and questions, school grades, and app behaviors of a student 250. The information of a student 250 may be assigned to a profile category (block 806), such as the profile category 708 introduced in FIG. 7. Further, based on Tiers C and D registration information, in one implementation, tags 706 (FIG. 7) may be added to the profile 704 (block 808).

In an implementation, an AI companion 204 may recommend a relevant activity, which may include, but is not limited to, one or more of the interactive content 206 shown in FIG. 6, based on an assignment (block 810). A student 250 may, in one implementation, select the interactive content 206 recommended by an AI companion 204 or the student may select from additional interactive content 206, such as from a pull-down menu viewable on a dashboard 202 (block 812).

A student 250 may complete an interactive content 206 (block 814). In an implementation, a student 250 may elect to receive hints to help complete the interactive content 206. Valuation 208 (e.g., points 210, FIG. 2) may be issued to reflect the progress of a student 250 (block 816) and points 210 may be displayed on a dashboard 202 (block 818), in one implementation. Of the points 210 accrued for completing interactive content 206, some points 210 may be deducted for receiving hints, for example. In addition to receiving points 210 for completing interactive content 206, a student 250 may receive points 210 for achieving a career milestone. In an implementation, a student 250 may optionally redeem points 210, such as by utilizing a point store/prize redemption function 622 (FIG. 6).

Upon completion of interactive content 206, for example, an AI companion 204 may update a brag book 214, which, in one implementation, captures and tracks performance of a student 250 (block 820). In an implementation, the points 210 of the student 250 may be measured against the points of other students using the electronic infrastructure 200. Achieving a high point score relative to other students for a given activity may the basis for entry in a brag book 214, as one example. In addition to a brag book 214, other actions of a student 250 and other behavioral metrics may be captured to train an AI companion 206 for more tailored recommendations.

In one or more implementations, an electronic infrastructure 200 may provide a wealth of learning opportunities for a student 250. An electronic infrastructure 200 may, for example, employ one or more of video-first learning, social media learning, interactive infrastructures, and emerging technologies, to name a few, to facilitate learning by a student 250.

Regarding video-first learning, studies show that students may increasingly prioritize and may be comfortable with video learning over traditional methods like textbooks or lectures. The popularity of You Tube for all age groups may be a testament to this. Younger students may particularly value user-generated content. An electronic infrastructure 200 may incorporate real-world examples and peer-to-peer learning aspects.

Regarding social media learning, while not strictly for academic learning, social media infrastructures (e.g., Instagram Live or Snapchat) may, in one or more implementations of an electronic infrastructure 200, be leveraged for educational purposes. Bite-sized content, live question and answer sessions, and educational influencers may be utilized, for example, to engage with a student 250.

Regarding interactive infrastructures, gamification resonates well with most people. One or more implementations of an electronic infrastructure 200 may incorporate game mechanics, such as points, badges, or leaderboards, as described above, to boost engagement.

Regarding emerging technologies, students today may be comfortable with new technologies. An electronic infrastructure 200 may, in an implementation, incorporate the use of Artificial Intelligence, which may provide robust learning tools or chatbots to personalize the learning experience. As new technologies evolve, an electronic infrastructure 200 may optionally utilize new technologies to facilitate learning.

Additionally, in one implementation, an electronic infrastructure 200 may prioritize variety in helping a student 250 to learn. Some students may be more attuned to video while others prefer the written word. An electronic infrastructure 200 may integrate various media, including, but not limited to, audio, images, and interactive elements, to cater to different learning styles. By providing transparent and purpose-driven content, a student 250, for example, may realize they may be receiving an authentic learning experience with an electronic infrastructure 200, which also, in one implementation, may incorporate features that foster interaction and collaboration among learners.

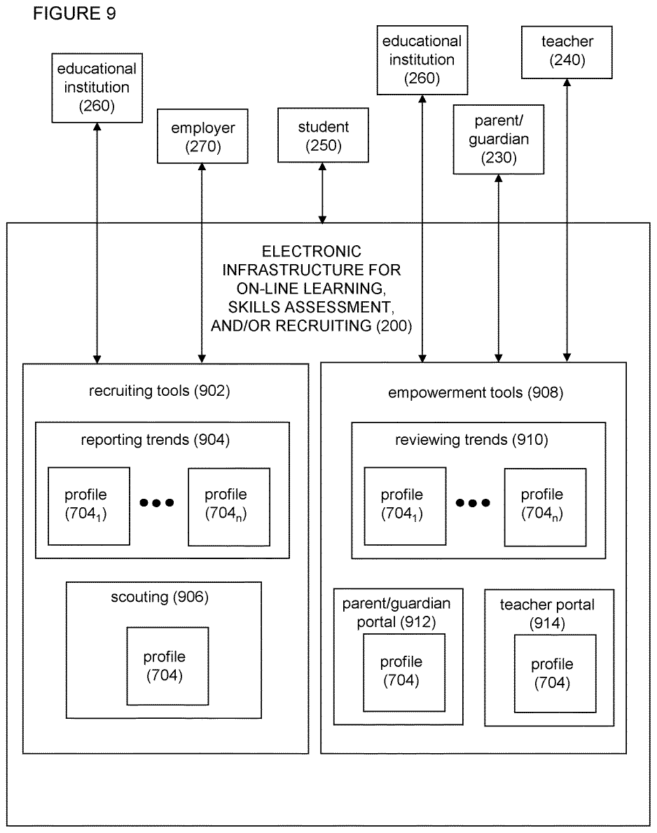

FIG. 9 is a schematic representation showing recruiting tools 902 and empowerment tools 908 that may be available on an electronic infrastructure 200. In an implementation, recruiting tools 902 may use a profile 704 to recruit a student 250 for educational and employment opportunities. Recruiting tools 902 may, for example, feature both reporting trends 904 and scouting 906. In one implementation, reporting trends 904 may use profiles of n students (profiles 7041 . . . 704n) for integer n, in other words, profiles of more than a single student. For example, reporting trends 904 may utilize profiles of all students using an electronic infrastructure 200 or a subset of all students. In another implementation, scouting 906 may use a single profile 704 of a student 250, although, for example, scouting 906 may optionally be done based on profiles of multiple students. Recruitment tools 902 are explained in more detail in FIG. 10.

Users who may use, in whole or in part, an electronic infrastructure 200 are shown in FIG. 9. In one implementation, all users (parents/guardians 230, teachers 240, students 250, educational institutions 260, and employers 270) may optionally access both the recruiting tools 902 and the empowerment tools 908. In an implementation, the recruiting tools 902 may be used, in whole or in part, by an educational institution 260 and/or an employer 270. Empowerment tools 908, in an implementation, may be used, in whole or in part, by an educational institution 260, such as a college or university, a parent/guardian 230, and/or a teacher 240.

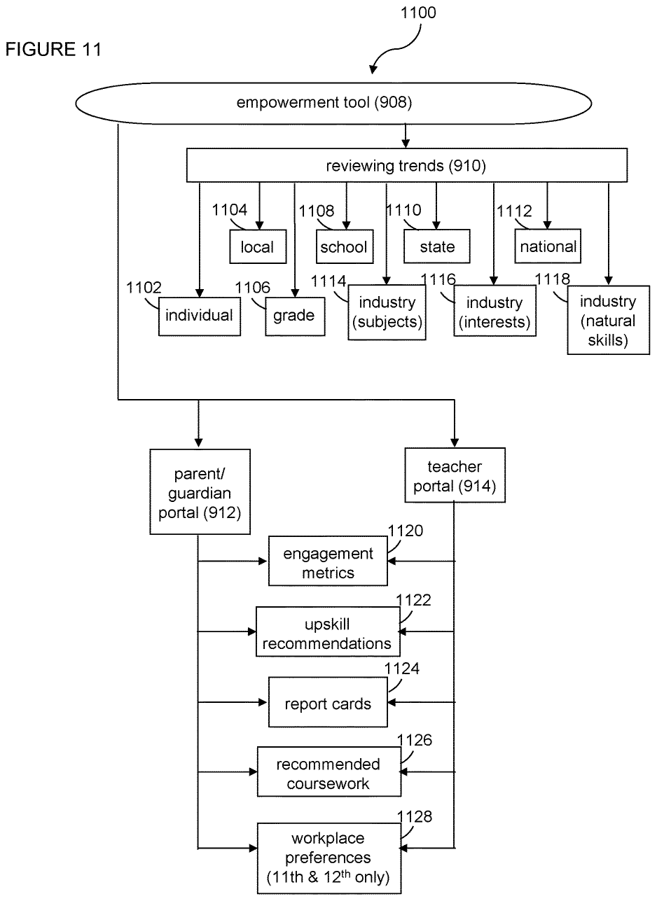

Empowerment tools 908 comprise reviewing trends 910, a parent/guardian portal 912, and a teacher portal 914. In an implementation, reviewing trends 910 may use profiles of n students (profiles 7041 . . . 704n) for integer n, in other words, profiles of more than a single student. Reviewing trends 904 may optionally utilize the profiles of all students using an electronic infrastructure 200 or a subset of all students. A parent/guardian portal 912 and a teacher portal 914 may use a single profile 704 of one student 250, although the parent/guardian portal 912 and the teacher portal 914 may also be done based on profiles of multiple students. In an example implementation, empowerment tools 908 may be based on interactive content 206, as shown in FIG. 6, of a student 250. The empowerment tools 908 are explained in more detail in FIG. 11.

An educational institution 260 and an employer 270 may use recruiting tool 902 to perform searches on an electronic infrastructure 200. In one implementation, an educational institution 260 and an employer 270 may, for example, filter through the many students using an electronic infrastructure 200 to reach those student or students suitable for scouting 906 opportunities. For example, students may appear in the search results based on their profile 704, which may include, but are not limited to, tags 706, valuation 208, and profile category 708 (FIG. 7).

Once a student 250 is no longer of a certain age (e.g., no longer 13, 18, etc.), which may depend, at least in part, on a particular state, country, jurisdiction, legal requirements, etc. and may make decisions for themselves, an educational institution 260 and an employer 270 may, in one implementation, see the name of the student 250 as well as their location in an electronic infrastructure 200. In contrast, in one implementation, to protect those students who may be of a certain age, as indicated above, an anonymous profile with a username may be visible in an electronic infrastructure 200 (such students may not likely be able to work/attend college).

Educational institutions 260 and employers 270 may, for example, use an electronic infrastructure 200 for scouting, reporting, and observing different trends. In an implementation, preset search parameters may be made available to educational institutions 260 and employers 270, which may enable them to observe applicants and potential candidates based, for example, on their industry interest, how well they're performing in school, where they're located, and their engagement on the site, among other criteria, the latter of which may, for example, may demonstrate a level of commitment of a student 250, an indicator that may have heretofore been somewhat elusive to educational institutions 260 and employers 270.

Educational institutions 260 and employers 270 may, for example, also be able to observe different tags 706 of a student 250 based on interactive content 206 utilized by the student. Educational institutions 260 and employers 270 may further consider extracurricular activities and hobbies of a student 250, in one implementation, using an electronic infrastructure 200, to ascertain the well-roundedness of the student. Educational institutions 260 and employers 270 may determine whether an electronic infrastructure 200 may be a purpose-driven initiative for the student or something else. In an example implementation, this determination may be made based on skillsets (soft and/or hard skills) and/or aptitude or pre-requisites required for admission and/or employment.

FIG. 10 is a process flow illustrating operations available under a recruiting tool 902 of an electronic infrastructure 200, according to an implementation. In an implementation, a recruiting tool 902 may be unlocked using AI technology, wherein unlocking may be achieved by paying for an electronic infrastructure 200. As shown also in FIG. 10, the features of a recruiting tool 902, according to one implementation, may be divided into two sections: reporting trends 904 and scouting 906. Recruiting tool 902 may, for example, be an end-to-end tool available to an educational institution 260 and an employer 270.

In one implementation, reporting trends 904 may enable an educational institution 260 and an employer 270 to observe different trends of students using an electronic infrastructure 200. An educational institution 260 and an employer 270 may, for example, learn about trends that may be local 1002, such as trends of a particular school, city, or county. In an implementation, the electronic infrastructure 200 may include an embedded search engine (e.g., Boolean) that may enable the educational institution 260 and the employer 270 to conduct these searches with ease.

In an implementation, an educational institution 260 and an employer 270 may learn about trends of a state 1004, which means they may, for example, obtain trend information for each of the fifty states individually, for their home state, for a group of states, and so on. A state 1004 reporting trends feature 904 may, for example, be relevant to an employer 270 who may be looking for a workforce suited to a particular industry or company. An employer may know a Toyota plant may be about to open in Mississippi and may optionally consult a state trend 1004 of the electronic infrastructure 200 to find out whether there may be students having the skills needed to work in the factory of the Mississippi plant, as one example.

In an implementation, an educational institution 260 and an employer 270 may learn about trends which may be national 1006. The United States may be gearing up its chip-making capability and plans to invite Toshiba to build plants within the country but cannot decide how many plants to build or where to construct them. By consulting the national trends 1006, Toshiba may, for example, be able to obtain information relevant to whether they may be able to recruit local talent for their factories and may even be able to determine the best locations for these sites. Educational institutions 260 may also, for example, obtain local 1002, state 1004, and national 1006 trends and may decide to offer courses in subjects that were not taught previously, using the reporting trends 904 feature of an electronic infrastructure 200. These are but a few examples of reporting trends 904 which may be available using a recruiting tool 902 of an electronic infrastructure 200 and are not meant to be limiting. As another example, if there is a trend showing higher engagement with space-related content, this may be indicative of student interest in learning more about jobs within the space industry. As a result, an educational institution 260 may consider offering coursework/classes for a degree pathway in the space industry. Educational institutions 260 likewise may advertise themselves as “leading” institutions in space-related academic disciplines.

In an implementation, an educational institution 260 and an employer 270 may learn about trends related to industry (subjects) 1008, industry (interests) 1010, and industry (natural skills) 1012. For industry (subjects) 1008 trend, an educational institution 260 and an employer 270 may, for example, obtain likely industries that may be relevant based on selected subjects. So, if, for example, a subject selected may be geography, an electronic infrastructure 200 may provide information about how students using the infrastructure may be performing in geography, as well as relevant industries that would be able to hire students adept at geography.

For an industry (interests) 1010 trend, an educational institution 260 and an employer 270 may, for example, obtain likely industries that may be relevant based on selected interests. So, if an interest selected may be filmmaking, an electronic infrastructure 200 may, for example, provide information about how students using the infrastructure that have expressed an interest in filmmaking, as well as relevant industries that would be in the position to hire students wanting to enter the field of filmmaking.

For an industry (natural skills) 1012 trend, an educational institution 260 and the employer 270 may, for example, obtain likely industries that may be relevant based on selected natural skills. So, if a natural skill selected may be rock climbing, an electronic infrastructure 200 may provide information about how students using the infrastructure that may have expressed an interest in rock climbing, as well as relevant industries that may be in a position to hire students having this natural skill. In an example implementation, recruiting tools 902 may be based on interactive content 206, as shown in FIG. 6, of a student 250. These are but a few examples of reporting trends 904 which may be available using a recruiting tool 902 of an electronic infrastructure 200 and are not meant to be limiting.

Using an electronic infrastructure 200, an educational institution 260 and an employer 270 may, for example, learn about trends related to workplace preferences 1014. In an implementation, this trend may be available for students in 11th and 12th grades. A workplace preference 1014 of each student using an electronic infrastructure 200 may, in one implementation, be indicated in a profile 704 of the student. Indicia such as a preference for working outdoors, working in teams, travel, remote work, and other characteristics of a student 250 may be gleaned by an AI companion 204 and may, for example, be part of a profile 704 and thus available to determine a workplace preference trend 1014.

In an implementation, a scouting portion 906 of the recruiting tools 902 may enable an educational institution 260 and an employer 270 to establish a mutually beneficial relationship with a student 250 based on information that may be gleaned from an electronic infrastructure 200 about a student 250. In an implementation, a scouting portion 906 may be available to an educational institution 260 and an employer 270 if, for example, the parent account may be linked, the relevant parties (e.g., teacher, principal, tutor) may be contacted, consent may be granted by the student, the latter of which may, for example, be available for students who may be eighteen or older, or other criteria are met.

In one implementation, as part of a scouting operation 906, an educational institution 260 and an employer 270 may, for example, access one or more student search parameters 1016. Student search parameters 1016 may, for example, enable an educational institution 260 and an employer 270 to engage in interviewing 1030, sourcing 1032, and contacting 1034 a student 250. In one implementation, sourcing 1032 involves making decisions about who to contact (e.g., creating a short list of candidates to reach out to), similar to following 606 (FIG. 6). Student search parameters 1016 may, for example, be available to an educational institution 260 and an employer 270 by a pull-down menu or other mechanism visible on a dashboard 202 of an electronic infrastructure 200.

In an implementation, student search parameters 1016 may include, but are not limited to, industry interests 1018, location 1020, tags 1022, common core subject ranking 1024, engagement 1026, and extracurriculars 1028. Industry interests 1018 may be, for example, those industries associated with a student 250 based on their engagement with an AI companion 204 over their continued use of the electronic infrastructure 200. Location 1020 may, for example, be used, in whole or in part, by an educational institution 260 and/or an employer 270 when looking for students within a predetermined distance of a geographical region. An educational institution 260 may, for example, make offers to a certain number of students within a state, and may therefore use a location 1020 student search parameter 1016 of scouting feature 906.

An educational institution 260 and an employer 270 may, for example, access tags 1022 (which, in an implementation, may be retrieved from tags 706 of the profile 704, FIG. 7) in the process of interviewing 1030, sourcing 1032, and contacting 1034 a student 250. An educational institution 260 and an employer 270 may, for example, access common core subject ranking 1024 as a student search parameter 1016, such as to retrieve star students in a particular subject. This targeted approach may enable an employer 270 to couple a student 250 with appropriate employment opportunities and enables an educational institution 260 to offer academic scholarships to the student.

An engagement 1026 option may, for example, enable an educational institution 260 and an employer 270 to find students. Using valuation 208 (FIG. 2), an employer 270 or educational institution 260 may be able to filter results based on point value tiers, e.g., a student with 5000 or more points is deemed by the employer 270 or educational institution 260 as a “power user” of an electronic infrastructure 200, which may indicate which students are showing the most initiative on the platform. An extracurriculars 1028 option may, for example, enable an educational institution 260 and an employer 270 to find students with particular skills, such as tennis stars, Mathletes, and so on. Thus, in one or more implementations, student search parameters 1016 may enable an educational institution 260 and an employer 270 using an electronic infrastructure 200 to quickly find a student or group of students for interviewing 1030, sourcing 1032, and contacting 1034.

FIG. 11 is a process flow illustrating operations available under an empowerment tool 908 of an electronic infrastructure 200. In an implementation, an empowerment tool 908 may be unlocked (paid for) using AI technology. An empowerment tool 908 may, for example, be utilized by one or more of a parent/guardian 230, a teacher 240, and an educational institution 260.

As shown also in FIG. 9, in an implementation, empowerment tools 908 may include at least three sections: reviewing trends 910, parent/guardian portal 912, and teacher portal 914. Reviewing trends 910 portion may, for example, enable a parent/guardian 230, a teacher 240, and/or an educational institution 260 to observe trends filtered into multiple categories. In one implementation, the categories may include, but are not limited to: individual 1102, local 1104, grade 1106, school 1108, state 1110, national 1112, industry (subjects) 1114, industry (interests) 1116, and industry (natural skills) 1118. Reviewing trends 910 may be available to a parent/guardian 230, a teacher 240, a student 250, and/or an educational institution 260 by, as one non-limiting example, a pull-down menu or other mechanism, such as one visible on a dashboard 202 of an electronic infrastructure 200.

Reviewing trends 910 may, for example, enable a parent/guardian 230, a teacher 240, and an educational institution 260 to gain an understanding about the students using an electronic infrastructure 200 based on the trends categories. Local 1104, state 1110, and national 1112 trends and the industry (subjects) 1114, industry (interests) 1116, and industry (natural skills) 1118 trends may, for example, operate much like the like-named trends in recruiting tool 902 (FIG. 10).

An individual 1102 trend may, for example, provide a parent/guardian 230, a teacher 240, and an educational institution 260 access to one or more of performance/engagement/potential pathway of student 250. A school 1108 trend may, for example, provides a parent/guardian 230, a teacher 240, and an educational institution 260 with access to students attending a particular school who may use an electronic infrastructure 200. A grade 1106 trend may provide, for example, a parent/guardian 230, a teacher 240, and an educational institution 260 with access to students within a particular grade who may be using an electronic infrastructure 200.

In one implementation, reviewing trends portion 910 of an empowerment tool 908 may be geared toward an educational institution 260. Nevertheless, a parent/guardian 230 and a teacher 240 may optionally use reviewing trends 910 as well. A parent/guardian 230 may, for example, study reviewing trends 910 to get an idea where their child fits in with their school, their grade, and so on. A teacher 240 may, for example, study how students in her classroom may be performing compared to other students in the same grade, other students in the same school, students in their city, and so on.

In one implementation, empowerment tools 909 may further include a parent/guardian portal 912 and a teacher portal 914, both of which may be connected to engagement metrics 1120, upskill recommendations 1122, report cards 1124, recommended coursework 1126, and workplace preferences 1128, the latter of which may be available for 11th and 12th graders. Although parent/guardian portal 912 and teacher portal 914 are, in this example, able to access the same categories, there may be other categories not shown that may be available to one but not both portals, as appropriate. One or more of the disclosed features may empower a student 250, such as with the help of a parent/guardian 230 and/or a teacher 240. In addition to studying reviewing trends 910, a student's teacher, for example, may access one or more of engagement metrics 1120, upskill recommendations 1122, report cards 1124, recommended coursework 1126, and workplace preferences 1128 and, from this information, make recommendations about coursework for a student for the next year.

Using a parent/guardian portal 912, a parent/guardian 230 may, for example, be more closely in tune to the progress of a student 250. While parents normally only see a student's teacher once per semester, an electronic infrastructure 200 may provide to a parent/guardian 230, for example, ongoing access to their child's development. Upskill recommendations 1122, for example, may provide a parent/guardian 230 with a list of age-appropriate skills that may help a student 250 be on track to meet their future employment goals. Report cards 1124 may, for example, provide a teacher 240 with the entire school reporting history for a given student 250, at least for those students who enter their report card information into an electronic infrastructure 200, which may thus enable overall evaluation/assessment of common core performance of student 250 to be made.

In one implementation, engagement metrics 1120 may provide a parent/guardian 230 and/or a teacher 240 with characteristics about a student 250 based on their engagement with an electronic infrastructure 200 over time. Engagement metrics 1120 may be, for example, based on tags 706 of a profile 704, where tags 706 may provide characteristics plus behaviors (e.g., content completed, points received, badges, etc.) about a student 250.

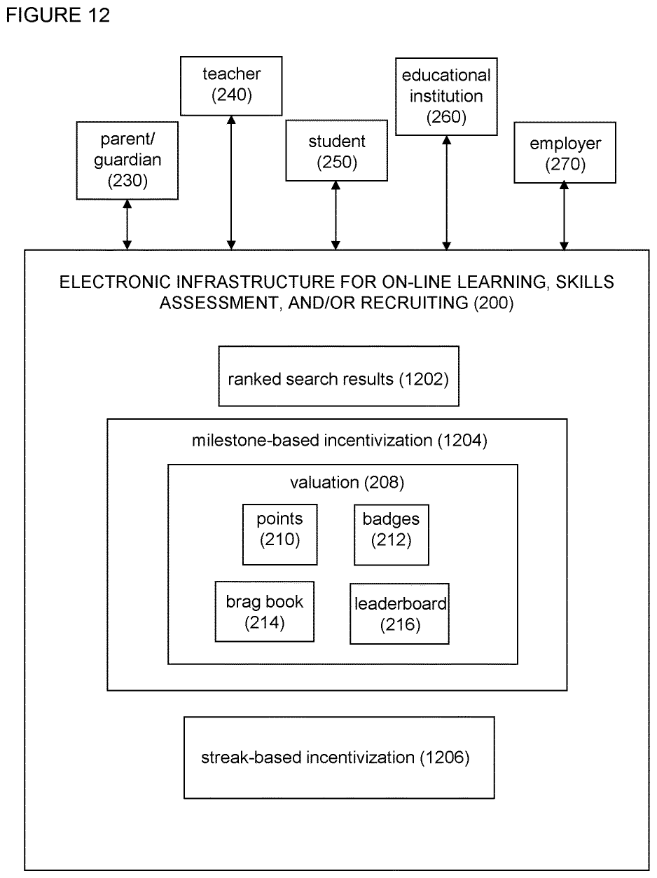

FIG. 12 is a schematic representation of additional incentivization that may be offered by an electronic infrastructure 200, according to an implementation. An electronic infrastructure 200 may generate a listing of ranked search results 1202, which may, for example, rank students based on industry relevancy, progression, point total, and so on, for use by interested parties, e.g., educational institutions 260 and employers 270. Interactive content 206 executed by a student 250 may, for example, teach an AI companion 204 how to better understand the competency and aptitude of the student, which, in one implementation, may enhance the functionality of an activity algorithm 702 (FIG. 7) within an electronic infrastructure 200. Ranked search results 1202 may or may not be part of the profile 704 of student 250.

In an implementation, an electronic infrastructure 200 incentivizes use of interactive content 206 by a student 250. Milestone-based incentives 1204 may, for example, be presented in the form of valuation 208, some of which may be redeemable (e.g., points 210), badges 212 (for longer-term achievements), a brag book 214 (indicates milestones), and a leaderboard 216 (which may indicate relative position of student). In an implementation, milestone-based incentives 1204 may be shown on a dashboard 202, such as to remind a student 250 of their achievements.

In an implementation, students 250 may be categorized as having high engagement, that is, they log into an electronic infrastructure 200 on a regular basis (e.g., daily), low engagement, meaning the student 250 has not logged into the infrastructure for a time (e.g., more than 10-30 days), or somewhere in between (medium engagement). For a high-engagement student, milestone-based incentivization 1204 may be sufficient motivation, while, for a low engagement student, a different incentive may be appropriate. In an implementation, an electronic infrastructure 200 may provide streak-based incentivization 1206. In streak-based incentivization 1206, for example, a student 250 may be prompted to engage and may be rewarded for increasing their engagement with an electronic infrastructure 200. A student 250 may receive extra points, for example, for logging in every day for a week.

With possible help of an AI companion 204, a student 250 may be given early exposure to ease them into the real world of work. In an implementation, an electronic infrastructure 200 may empower a student 250 to create their own career experience according to their own desires. An electronic infrastructure 200 may provide an opportunity to explore the path that may be best to pursue following school, while also giving a student 250 the time to endure through times of questioning, discomfort, unfamiliarity, and uncertainty. An electronic infrastructure 200 may, in one or more implementations, make career education a fun, engaging, and unique way for a student 250 to commence career exploration well in advance of entering the workforce.

While certain example techniques have been described and shown herein using various methods or systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
receiving, at a client device, one or more digital signals indicating an uploaded electronic content comprising a host application for use by the client device;
receiving, at the client device, one or more digital signals indicative of a registration process activated via the host application;
generating, via the client device, one or more digital signals comprising an electronic profile based, at least in part, on the registration process; and
making available, via the client device, one or more digital signals comprising an interactive content based, at least in part, on the electronic profile.

2. The method of claim 1, and further comprising:
generating, via the client device, one or more digital signals comprising a companion feature based, at least in part, on the electronic profile.

3. The method of claim 2, wherein the interactive content is generated, at least in part, by the companion feature.

4. The method of claim 3, and further comprising:
generating, via the client device, one or more digital signals comprising at least a value based, at least in part, on the interactive content.

5. The method of claim 4, and further comprising:
making available, via the client device, the value, in whole or in part, for use by one or more additional processes.

6. The method of claim 2, wherein the companion is based, at least in part, on one or more Artificial Intelligence processes.

7. The method of claim 4, wherein the value comprises at least one of the following: a numerical value; an alphanumeric value; a point; a symbol; a flag; a badge; or any combination thereof.

8. The method of claim 5, wherein a process of the one or more additional processes comprises at least one of the following: a dashboard visible on a display of the client device; a teaching feature; an educational institution feature; an employer feature; a parent or guardian feature; generating a cash equivalent for the value; a point store for redeeming the value; a recruiting tool feature; an empowerment tool feature; or any combination thereof.

9. The method of claim 1, wherein the registration further comprises, at least in part, third information associated with the user.

10. The method of claim 9, wherein the third information comprises, at least one of the following: a hobby; an assessment question, a learning preference; or any combination thereof.

11. The method of claim 4, wherein the interactive content comprises at least one of the following: a game; a journal; a student “follow” function; a career intelligence coach; a “world of work” career readiness function; a group chat; a job simulator; a point store; a career path recommendation function; a course selection; a career path planning function; or any combination thereof.

12. The method of claim 8, wherein the recruiting tool feature is based, at least in part, on a plurality of electronic profiles.

13. The method of claim 12, and further comprising:
making available, via the client device, one or more digital signals comprising reporting trends based, at least in part, on the recruiting tool feature.

14. The method of claim 13, wherein the reporting trends comprise at least one of the following: local trends; state trends; national trends; industry (subject) trends; industry (interest) trends; industry (natural skill) trends; workplace preferences; or any combination thereof.

15. The method of claim 12, and further comprising:
making available, via the client device, one or more digital signals comprising a scouting operation based, at least in part, on the recruiting tool feature.

16. The method of claim 15, wherein the scouting operation employs search parameters, the search parameters comprising at least one of the following: industry interests; location; tags; common core subject ranking; engagement; extracurriculars;
or any combination thereof.

17. The method of claim 15, wherein the scouting operation comprises:
interviewing; sourcing; contacting; or any combination thereof.

18. The method of claim 8, wherein the empowerment tool feature is based, at least in part, on a plurality of electronic profiles.

19. The method of claim 18, wherein the reviewing trends comprise at least one of the following: individual trends; local trends; grade trends; school trends; state trends; national trends; industry (subjects) trends; industry (interests) trends; industry (natural skills) trends; or any combination thereof.

20. The method of claim 18, and further comprising:
making available, via the client device, one or more digital signals comprising a parent/guardian portal based, at least in part, on the empowerment tool feature.

21. The method of claim 20, wherein the parent/guardian portal comprises at least one of the following: engagement metrics; upskill recommendations; report cards; recommended coursework; workplace preferences; or any combination thereof.

22. The method of claim 18, and further comprising:
making available, via the client device, one or more digital signals comprising a teacher portal based, at least in part, on the empowerment tool feature.

23. The method of claim 22, wherein the teacher portal comprises at least one of the following: engagement metrics; upskill recommendations; report cards;
recommended coursework; workplace preferences; or any combination thereof.

24. An apparatus comprising:
a wireless transceiver to transmit and receive digital signals to and from a network via a communication link; and one or more processors coupled to a memory to execute a program to:
receive, at a client device, one or more digital signals indicative of an uploaded electronic content comprising a host application for use by the client device; receive, at the client device, one or more digital signals indicative of a registration process activated via the host application;
generate, via the client device, one or more digital signals comprising an electronic profile based, at least in part, on the registration process;
and make available, via the client device, one or more digital signals comprising an interactive content based, at least in part, on the electronic profile.

25. The apparatus of claim 24, wherein the client device comprises at least one of the following: a mobile device; a desktop computing device; a laptop computing device; a tablet device; or any combination thereof.

26. A non-transitory storage medium comprising instructions executable by a processor to:
receive, at a client device, one or more digital signals indicative of an uploaded electronic content comprising a host application for use by the client device;
receive, at the client device, one or more digital signals indicative of a registration process activated via the host application;
generate, via the client device, one or more digital signals comprising an electronic profile based, at least in part, on the registration process; and
make available, via the client device, one or more digital signals comprising an interactive content based, at least in part, on the electronic profile.

27. The non-transitory storage medium of claim 26, and further comprising instructions executable by the processor to:
generate, via the client device, one or more digital signals comprising a companion feature based, at least in part, on the electronic profile.

28. The non-transitory storage medium of claim 27, wherein the interactive content is generated, at least in part, by the companion feature.

29. The non-transitory storage medium of claim 28, and further comprising instructions executable by the processor to:
generate, via the client device, one or more digital signals comprising at least a value based, at least in part, on the interactive content.

30. The non-transitory storage medium of claim 29, and further comprising instructions executable by the processor to:
make available, via the client device, the value, in whole or in part, for use by one or more additional processes.

31. The non-transitory storage medium of claim 27, wherein the companion is based, at least in part, on one or more Artificial Intelligence processes.

32. The non-transitory storage medium of claim 29, wherein the value comprises at least one of the following: a numerical value; an alphanumeric value; a point; a symbol; a flag; a badge; or any combination thereof.

33. The non-transitory storage medium of claim 30, wherein a process of the one or more additional processes comprises at least one of the following: a dashboard visible on a display of the client device; a teach feature; an educational institution feature; an employer feature; a parent or guardian feature; a cash generation equivalent for the value; a point store to redeem the value; a recruitment tool feature; an empowerment tool feature; or any combination thereof.

34. The non-transitory storage medium of claim 26, wherein the registration further comprises, at least in part, third information associated with the user.

35. The non-transitory storage medium of claim 34, wherein the third information comprises, at least one of the following: a hobby; an assessment question, a learn preference; or any combination thereof.

36. The non-transitory storage medium of claim 35, wherein the third information is at least partially stored in a third database.

37. The non-transitory storage medium of claim 26, wherein the fourth information is at least partially stored in a fourth database.

38. The non-transitory storage medium of claim 29, wherein the interactive content comprises at least one of the following: a game; a journal; a student “follow” function; a career intelligence coach; a “world of work” career readiness function; a group chat; a job simulator; a point store; a career path recommendation function; a course selection; a career path planning function; or any combination thereof.

39. The non-transitory storage medium of claim 33, wherein the recruitment tool feature is based, at least in part, on a plurality of electronic profiles.

40. The non-transitory storage medium of claim 39, and further comprising instructions executable by the processor to:
make available, via the client device, one or more digital signals comprising report trends based, at least in part, on the recruitment tool feature.

41. The non-transitory storage medium of claim 40, wherein the report trends comprise at least one of the following: local trends; state trends; national trends; industry (subject) trends; industry (interest) trends; industry (natural skill) trends; workplace preferences; or any combination thereof.

42. The non-transitory storage medium of claim 39, and further comprising instructions executable by the processor to:
make available, via the client device, one or more digital signals comprising a scouting operation based, at least in part, on the recruitment tool feature.

43. The non-transitory storage medium of claim 42, wherein the scout operation employs search parameters, the search parameters comprising at least one of the following: industry interests; location; tags; common core subject rank; engagement; extracurriculars; or any combination thereof.

44. The non-transitory storage medium of claim 42, wherein the scout operation comprises: interviews; sources; contacts; or any combination thereof.

45. The non-transitory storage medium of claim 33, wherein the empowerment tool feature is based, at least in part, on a plurality of electronic profiles.

46. The non-transitory storage medium of claim 26, wherein the review trends comprise at least one of the following: individual trends; local trends; grade trends; school trends; state trends; national trends; industry (subjects) trends; industry (interests) trends; industry (natural skills) trends; or any combination thereof.

47. The non-transitory storage medium of claim 45, and further comprising instructions executable by the processor to:
make available, via the client device, one or more digital signals comprising a parent/guardian portal based, at least in part, on the empowerment tool feature.

48. The non-transitory storage medium of claim 47, wherein the parent/guardian portal comprises at least one of the following: engagement metrics; upskill recommendations; report cards; recommended coursework; workplace preferences; or any combination thereof.

49. The non-transitory storage medium of claim 45, and further comprising instructions executable by the processor to:
make available, via the client device, one or more digital signals comprising a teacher portal based, at least in part, on the empowerment tool feature.

50. The non-transitory storage medium of claim 49, wherein the teacher portal comprises at least one of the following: engagement metrics; upskill recommendations; report cards; recommended coursework; workplace preferences; or any combination thereof.
